(19) United States
(12) Patent Application Publication
(10) Pub. No.: US 2005/0093470 A1
(43) Pub. Date: May 5, 2005

(54) Method and apparatus for driving plasma display panel

(76) Inventor: Hak-Ki Choi, Cheonan-si (KR)

Correspondence Address: McGuireWoods LLP, Suite 1800, 1750 Tysons Boulevard, McLean, VA, 22102, US

(21) Appl. No.: 10/976,211

(22) Filed: Oct. 29, 2004

(30) Foreign Application Priority Data
Oct. 30, 2003 (KR) 2003-0076198

(51) Int. Cl. G09G 3/10

(52) U.S. Cl. 315/169.4; 315/169.1

(57) ABSTRACT

A method and apparatus for driving a plasma display panel in which pairs of sustain electrodes lines respectively including X-electrode lines and Y-electrode lines that are alternately arranged parallel with each other are disposed to be orthogonal to address electrode lines, and discharge cells are defined by intersections between the sustain electrodes and the address electrode lines. In the method, a unit frame as a display period is divided into a plurality of subfields to realize time-division grayscale display, and the individual subfields include a reset period, an address period, and a sustain period. The method includes maintaining the Y-electrode lines at a reference level during the reset period and the sustain period; and addressing the Y-electrode lines by biasing the Y-electrode lines to a first level and simultaneously, sequentially applying a scan signal of the reference level to the Y-electrode lines during the address period.

This application claims priority to and the benefit of Korean Patent Application No. 10-2003-0076198, filed on Oct. 30, 2003, which is hereby incorporated by reference for all purposes as if fully set forth herein.

### BACKGROUND OF THE INVENTION

1. Field of the Invention

The present invention relates to a method and apparatus for driving a plasma display panel (PDP), and more particularly, to a method and apparatus for driving a PDP having a simplified scan electrode driving circuitry.

2. Discussion of the Related Art

FIG. 1 is an internal perspective view showing the structure of a typical surface discharge type triode PDP, and FIG. 2 is a cross-sectional view of a single discharge cell of the PDP shown in FIG. 1.

Referring to FIG. 1 and FIG. 2, address electrode lines A_{R1}, A_{G1}, . . . , A_{Gm}, A_{Bm}, dielectric layers 11 and 15, Y-electrode lines Y₁, . . . , Yₙ, X-electrode lines X₁, . . . , Xₙ, phosphor layers 16, barrier walls 17, and a protective layer 12, are provided between a front glass substrate 10 and a rear glass substrate 13 of the surface discharge PDP 1.

The address electrode lines A_{R1}, A_{G1}, . . . , A_{Gm}, A_{Bm} are formed on the front surface of the rear glass substrate 13 in a predetermined pattern. A rear dielectric layer 15 covers the address electrode lines A_{R1}, A_{G1}, . . . , A_{Gm}, A_{Bm}. The barrier walls 17 are formed on the rear dielectric layer 15 in between, and in parallel to, the address electrode lines A_{R1}, A_{G1}, . . . , A_{Gm}, A_{Bm}. The barrier walls 17 partition discharge regions of respective discharge cells and prevent cross talk between the discharge cells. The phosphor layers 16 are formed on the rear dielectric layer 15 and on the sides of the barrier walls 17.

The X-electrode lines X₁, . . . , Xₙ and the Y-electrode lines Y₁, . . . , Yₙ are formed in pairs on the rear surface of the front glass substrate 10 to be orthogonal to the address electrode lines A_{R1}, A_{G1}, . . . , A_{Gm}, A_{Bm}, and their intersections define discharge cells. Each of the X-electrode lines X₁, . . . , Xₙ and the Y-electrode lines Y₁, . . . , Yₙ may include a transparent electrode portion X₁ₐ, . . . , Xₙₐ and Y₁ₐ, . . . , Yₙₐ formed of a transparent conductive material, e.g., indium tin oxide (ITO), and a metal electrode portion X_{1b}, . . . , X_{nb} and Y_{1b}, . . . , Y_{nb}, for increasing conductivity. A front dielectric layer 11 covers the X-electrode lines X₁, X₂, . . . , Xₙ and the Y-electrode lines Y₁, Y₂, . . . , Yₙ. The protective layer 12, which may be formed of a magnesium oxide (MgO) layer, protects the panel 1 against a strong electrical field, and it is deposited on the front dielectric layer 11. A gas for forming plasma is hermetically sealed in a discharge space 14.

U.S. Pat. No. 5,541,618 discloses an address-display separation (ADS) driving is method for a PDP having the structure shown in FIG. 1.

FIG. 3 is a block diagram of a typical driving apparatus 2 for the PDP 1 of FIG. 1. Referring to FIG. 3, the driving apparatus 2 includes an image processor 26, a logic controller 22, an address driver 23, an X-driver 24, and a Y-driver 25. The image processor 26 converts an external analog image signal into an internal image signal, for example, 8-bit red (R) video data, 8-bit green (G) video data, and 8-bit blue (B) video data, a clock signal, a vertical synchronizing signal, and a horizontal synchronizing signal. The logic controller 22 generates drive controlling signals S_{A}, S_{Y}, and S_{X} in response to the internal image signals from the image processor 26.

The address driver 23 processes the address signal S_{A} to generate a display data signal and applies the display data signal to the address electrode lines. The X-driver 24 processes the X-drive controlling signal S_{X} and applies the result to the X-electrode lines. The Y-driver 25 processes the Y-drive controlling signal S_{Y} and applies the result to the Y-electrode lines.

FIG. 4 is a timing chart showing an ADS method of driving the PDP 1 of FIG. 1. Referring to FIG. 4, to realize time-division grayscale display, a unit frame may be divided into a plurality of subfields SF₁, . . . , SF₈. The individual subfields SF₁, . . . , SF₈ may be further divided into reset periods R₁, . . . , R₈, address periods A₁, . . . , A₈, and sustain periods S₁, . . . , S₈, respectively.

The luminance of the PDP 1 is proportional to a total length of the sustain periods S1, . . . , S8 in a unit frame, which is 255 T (T is a unit of time). A time 2ⁿ⁻¹ is set to a sustain period Sₙ of an nth subfield SFₙ. Thus, by appropriately selecting a subfield to display, display of 256 grayscales, including grayscale 0, may be performed.

FIG. 5 is a timing chart showing examples of drive signals applied in unit subfields shown in FIG. 4 to electrode lines of the PDP 1 shown in FIG. 1.

In FIG. 5, reference characters S_{AR1 . . . ABm} are drive signals applied to address electrode lines (A_{R1}, A_{G1}, . . . , A_{Gm}, A_{Bm} of FIG. 1), S_{X1 . . . Xn} are drive signals applied to X-electrode lines (X₁, . . . , Xₙ of FIG. 1), and S_{Y1 . . . Yn} are drive signals applied to Y-electrode lines (Y₁, . . . , Yₙ of FIG. 1).

Referring to FIG. 5, a unit subfield SF includes a reset period PR, an address period PA, and a sustain period PS. During the reset period PR, a voltage applied to the X-electrode lines X₁, . . . , Xₙ is raised from a ground voltage V_{G} to a first voltage Ve and simultaneously, a ground voltage V_{G} is applied to the Y-electrode lines Y₁, . . . , Yₙ and the address electrode lines A_{R1}, A_{G1}, . . . , A_{Gm}, A_{Bm}.

Next, a voltage applied to the Y-electrode lines Y₁, . . . , Yₙ is raised from a second voltage V_{S} (e.g., 155 V) to a maximum voltage (V_{SET}+V_{S}) (e.g., 355 V), and simultaneously, a ground voltage V_{G} is applied to the X-electrode lines X₁, . . . , Xₙ and the address electrode lines A_{R1}, A_{G1}, . . . , A_{Gm}, A_{Bm}.

Next, while a voltage applied to the X-electrode lines X₁, . . . , Xₙ is maintained at the second voltage V_{S}, a voltage applied to the Y-electrode lines Y₁, . . . , Yₙ reduces from the second voltage V_{S} to the ground voltage V_{G} while simultaneously applying a ground voltage V_{G} to the address electrode lines A_{R1}, A_{G1}, . . . , A_{Gm}, A_{Bm}.

Thus, during the address period PA, while applying display data signals to the address electrode lines A_{R1}, A_{G1}, . . . , A_{Gm}, A_{Bm}, a scan signal of the ground voltage V_{G} is sequentially applied to the Y-electrode lines Y₁, . . . , Yₙ, which are biased to a fourth voltage V_{SCAN}, to thereby address the Y-electrode lines Y₁, . . . , Yₙ. Applying display data signals of an address voltage V_{A} to the address electrode lines A_{R1}, A_{G1}, . . . , A_{Gm}, A_{Bm} selects the respective discharge cell, and a ground voltage V_{G} is applied to an address electrode line when the corresponding discharge cell is not to be selected. Thus, applying an address voltage V_{A} to an address electrode while applying the ground voltage V_{G} to the corresponding Y electroce generates wall charges in corresponding discharge cell due to an address discharge. To facilitate the address discharge, the first voltage Ve may be maintained at the X-electrode lines X₁, . . . , Xₙ during the address period.

During the sustain period PS, a sustain pulse of a second voltage V_{S} is alternately applied to the Y-electrode lines Y₁, . . . , Yₙ and the X-electrode lines X₁, . . . , Xₙ, thereby provoking a display discharge in those discharge cells that were selected during the address period PA.

FIG. 6 is a circuit diagram of a Y-driver of a conventional apparatus for driving a PDP, FIG. 7 is a timing chart showing examples of scan controlling signals applied to a scan drive integrated circuit (IC), and FIG. 8 is a timing chart showing examples of scan controlling signals used in a conventional method of driving a PDP.

Referring to FIG. 6, a Y-driver 25 processes Y drive controlling signals S_{Y} to generate a display data signal and applies it to the Y-electrode lines. The Y-driver 25 may include a circuit portion and a scan drive IC 251. The circuit portion applies various voltages (e.g., V_{S}, Vₛₑₜ, or V_{scan}) to the Y-electrode lines in the reset period PR, address period PA, and sustain period PS. The scan drive IC 251 enables sequential application of a scan pulse to the Y-electrode lines during the address period PA.

The scan drive IC 251 may include a plurality of output terminals and one scan drive IC may be formed for each Y-electrode line.

The scan drive IC 251 receives scan controlling signals as shown in FIG. 7 and outputs a scan pulse to the Y-electrode lines during the address period. Although the scan controlling signals may be changed depending on the type of the scan drive IC 251, they typically include a clock signal CLK, a data signal Data, a strobe signal STB, a blanking signal BLK, and a high impedance controlling signal HIZ.

The scan drive IC 251 outputs a scan pulse to the Y-electrode lines during the address period PA, and a discharge pulse and a reset pulse may pass through its internal diode path during the sustain period PS and reset period PR. Accordingly, as shown in FIG. 8, the scan drive IC 251 may be grounded at a floating electric potential level, which varies over time, instead of an absolute “0” level. A device for electrically isolating an input controlling signal of the scan drive IC 251 from its output controlling signal may be required to provide such a floating ground.

Conventionally, an optocoupler or a transformer may be used to electrically isolate the scan drive's input signal from the output signal. A typical apparatus for driving a PDP utilizes an optocoupler 252, as shown in FIG. 6. However, when producing PDPs in bulk, providing the optocoupler 252 may increases dispersion of components and defective products, thereby reducing yield.

### SUMMARY OF THE INVENTION

The present invention provides a method and apparatus for driving a PDP that does not require an isolating device in a scan drive integrated circuit.

Additional features of the invention will be set forth in the description which follows, and in part will be apparent from the description, or may be learned by practice of the invention.

The present invention discloses a method of driving a PDP in which X-electrode lines, Y-electrode lines and address electrode lines define discharge cells, and in which a unit frame as a display period is divided into a plurality of subfields to realize time-division grayscale display, and the individual subfields include a reset period, an address period, and a sustain period. The method comprises maintain the Y-electrode lines at a reference level during the reset period and the sustain period. During the address period, the Y-electrode lines are addressed by biasing the Y-electrode lines to a first level and simultaneously, a scan signal of the reference level is sequentially applied to the Y-electrode lines.

The present invention also discloses a method of driving a PDP in which X-electrode lines, Y-electrode lines and address electrode lines define discharge cells, and in which a unit frame as a display period is divided into a plurality of subfields to realize time-division grayscale display, and the individual subfields include a reset period, an address period, and a sustain period. The method comprises during the reset period, maintaining the Y-electrode lines at a first level in a first part of the reset period and at a reference level in a second part of the reset period. During the address periods, the Y-electrode lines are biased to the first level and simultaneously, a scan signal of the reference level is sequentially applied to address the Y-electrode lines. During the sustain period, a Y sustain pulse of the first level is applied to the Y-electrode lines.

The present invention also discloses an apparatus for driving a PDP in which X-electrode lines, Y-electrode lines and address electrodes define discharge cells, and in which a unit frame as a display period is divided into a plurality of subfields to realize time-division grayscale display, and the individual subfields include a reset period, an address period, and a sustain period. A controller generates a scan controlling signal, an address controlling signal, a reset/sustain controlling signal, and a common controlling signal. A Y-driver applies a scan drive signal to the Y-electrode lines in response to the scan controlling signal. An address driver applies an address drive signal to the address electrode lines in response to the address controlling signal. A reset/sustain circuit applies a reset/sustain drive signal to the X-electrode lines in response to the reset/sustain controlling signal. An X-driver applies a common drive signal to the X-electrode lines in response to the common controlling signal

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an internal perspective view showing a structure of a typical surface discharge type triode PDP.

FIG. 2 is a cross-sectional view showing a single discharge cell of the PDP of FIG. 1.

FIG. 3 is a block diagram showing a typical driving apparatus for the PDP of FIG. 1.

FIG. 4 is a timing chart showing a typical method of driving the PDP of FIG. 1.

FIG. 5 is a timing chart showing typical drive signals applied to electrode lines of the PDP of FIG. 1.

FIG. 6 is a circuit diagram showing a conventional Y-driver for a PDP.

FIG. 7 is a timing chart showing examples of scan controlling signals applied to a scan drive integrated circuit (IC) during scan drive in the apparatus shown in FIG. 6.

FIG. 8 is a timing chart showing examples of scan controlling signals used in a conventional method of driving a PDP.

FIG. 9 is a timing chart showing a method of driving a PDP according to an exemplary embodiment of the present invention.

FIG. 10 is a timing chart showing a method of driving a PDP according to a second exemplary embodiment of the present invention.

FIG. 11 is a block diagram showing a PDP driving apparatus according to an exemplary embodiment of the present invention.

FIG. 12 is a block diagram showing a scan driver of the apparatus shown in FIG. 11.

FIG. 13 is a timing chart showing examples of a scan drive signal used in the method according to exemplary embodiments of the present invention.

FIG. 14 is a circuit diagram showing an X-driver and a Y-driver of the PDP shown in FIG. 11.

### DETAILED DESCRIPTION OF THE ILLUSTRATED EMBODIMENTS

The following describes exemplary embodiments of the present invention with reference to the attached drawings.

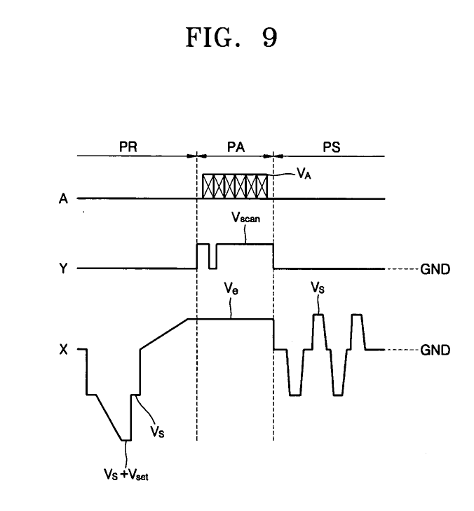

FIG. 9 is a timing chart showing a method of driving a PDP according to an exemplary embodiment of the present invention, and FIG. 13 is a timing chart showing examples of a scan drive signal used in the method according to the present invention.

Referring to FIG. 9, the Y-electrode lines Y₁, . . . , Yₙ are maintained at a reference level GND during the reset period PR and the sustain period PS. During the address period PA, the Y-electrode lines Y₁, . . . , Yₙ are biased to a first level V_{scan} while a scan signal of the reference level GND is sequentially applied to them.

During the reset period PR, with the Y-electrode lines Y₁, . . . , Yₙ at the reference level GND, the address electrode lines A_{R1}, A_{G1}, . . . , A_{Gm}, A_{Bm} are also maintained at the reference level GND, and a falling ramp pulse that falls from a second level V_{S} to a third level V_{S}+Vₛₑₜ is applied to the X-electrode lines X₁, . . . , Xₙ, and then a rising ramp pulse that rises from the reference level GND to a fourth level Vₑ is applied to the X-electrode lines X₁, . . . , Xₙ.

During the address period PA, the X-electrode lines X₁, . . . , Xₙ are maintained at the fourth level Vₑ, and the Y-electrode lines Y₁, . . . , Yₙ are biased to the first level V_{scan}. A scan signal of the reference level GND is sequentially applied to the Y-electrode lines Y₁, . . . , Yₙ to address the Y-electrode lines Y₁, . . . , Yₙ, and an address voltage V_{A} is applied to address electrode lines A_{R1}, A_{G1}, . . . , A_{Gm}, A_{Bm} of the discharge cells to be displayed. The address electrode lines are synchronized with the scan signal that is applied to the Y-electrode lines Y₁, . . . , Yₙ.

During the sustain period PS, a positive sustain pulse and a negative sustain pulse, each having a voltage at the second level V_{S}, are alternately applied to the X-electrode lines X₁, . . . , Xₙ while the Y-electrode lines Y₁, . . . , Yₙ and the address electrode lines A_{R1}, A_{G1}, . . . , A_{Gm}, A_{Bm} are maintained at the reference level GND.

Consequently, according to the first exemplary embodiment of the present invention, the scan pulsesare applied to the Y-electrode lines Y₁, . . . , Yₙ, and the sustain pulses and the reset pulses are applied to the X-electrode lines X₁, . . . , Xₙ.

Therefore, in the method of driving a PDP according to the first exemplary embodiment, the scan drive IC for the Y electrodes only needs to generate a scan pulse. Hence, a circuit portion for generating reset discharges and sustain discharges is not necessary. Accordingly, unlike a conventional PDP driving apparatus, the scan drive IC uses an absolute ground instead of a floating ground. Therefore, an isolating device for electrically isolating the scan drive IC to generate a floating ground is not required.

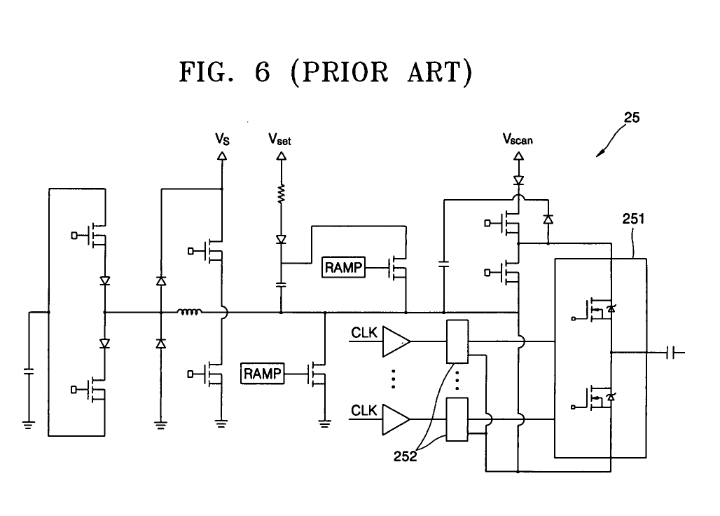

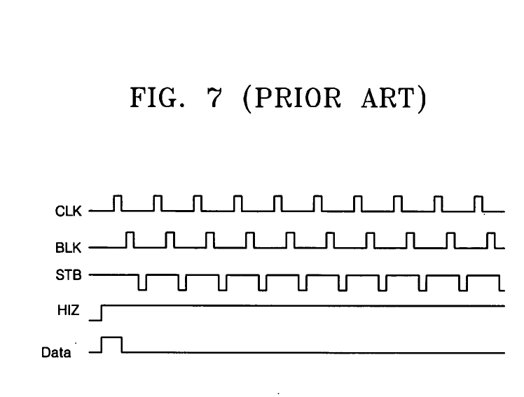

As a result, an optocoupler (252 of FIG. 6), which is typically used as the isolating device for a typical PDP driving apparatus, is not needed, which may increase yield when mass producing PDPs.

Further, since the scan drive IC may use the absolute ground instead of the floating ground, even the scan controlling signal applied to the scan drive IC may have a signal level required only for address periods on the basis of the absolute ground GND.

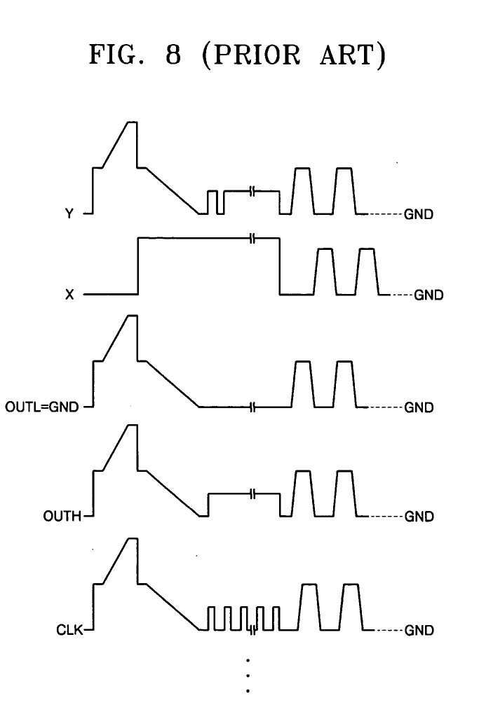

FIG. 13 shows examples of scan controlling signals, which are applied on the basis of an absolute ground instead of a floating ground, according to the first exemplary embodiment of the present invention. As compared to FIG. 8, a low-level signal OUTL, a high-level signal OUTH and a clock signal CLK having levels of an absolute ground GND.

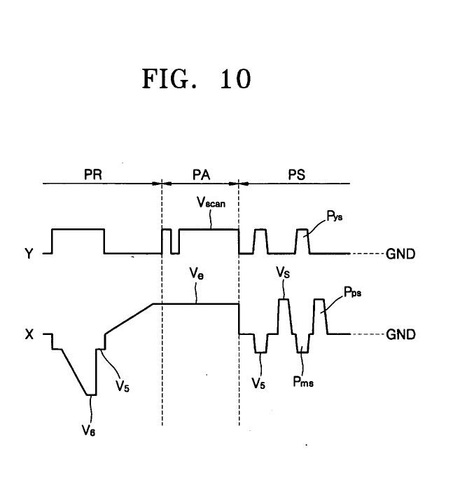

FIG. 10 is a timing chart showing a method of driving a PDP according to a second exemplary embodiment of the present invention.

Unlike the first exemplary embodiment, as shown in FIG. 10, a reset pulse and a sustain pulse may be applied to the Y electrodes Y₁, . . . , Yₙ. In a first part of the reset period PR, the Y-electrode lines Y₁, . . . , Yₙ are biased to a first level V_{scan} on the basis of a reference level GND, and they are maintained at the reference level GND during a second part of the reset period PR. During the address period PA, the Y-electrode lines Y₁, . . . , Yₙ are biased to the first level V_{scan}, and a scan signal of the reference level GND is sequentially applied to them. During the sustain period PS, a Y sustain pulse P_{ys} of the first level V_{scan} is applied to the Y-electrode lines Y₁, . . . , Yₙ.

In the first part of the reset period PR, a falling ramp pulse that falls from a fifth level V₅ to a sixth level V₆ is applied to the X-electrode lines X₁, . . . , Xₙ, and then a rising ramp pulse that rises from the reference level GND to a fourth level Vₑ is applied thereto in the second part. The address electrode lines A_{R1}, A_{G1}, . . . , A_{Gm}, A_{Bm} (not shown) are maintained at the reference level GND in the reset period PR.

The address period PA of the second exemplary embodiment is carried out similar to the address period PA of the first exemplary embodiment; hence, it is not discussed further here.

During the sustain period PS, a positive sustain pulse Pₚₛ, which has a second level V_{S} on the basis of the reference level GND, and a negative sustain pulse Pₘₛ, which has a fifth level V₅ on the basis of the reference level GND, are alternately applied to the X-electrode lines X₁, . . . , Xₙ. Also, a Y sustain pulse P_{ys}, having the first level V_{scan} on the basis of the reference level GND, is applied to the Y-electrode lines Y₁, . . . , Yₙ. The address electrode lines A_{R1}, AG₁, . . . , A_{Gm}, A_{Bm} (not shown) are maintained at the reference level GND.

Preferably, the Y sustain pulse P_{ys} is applied to the Y-electrode lines Y₁, . . . , Yₙ at the same time that the negative sustain pulse Pₘₛ is applied to the X-electrode lines X₁, . . . , Xₙ. In other words, it is preferable that a difference between the level of the Y sustain pulse P_{ys} and the level of the negative sustain pulse Pₘₛ equals a voltage V_{S}, which is a typical value for a conventional sustain pulse.

Accordingly, the fifth level V₅ preferably corresponds to a difference between the first level V_{scan} and the second level V_{S}. In this case, an electrical relationship between the X-electrodes and the Y-electrodes during the first reset period may be the same as in the conventional case.

Since the second exemplary embodiment as described with reference to FIG. 10 performs the same function as the first exemplary embodiment as described with reference to FIG. 9, a detailed description thereof is not repeated here.

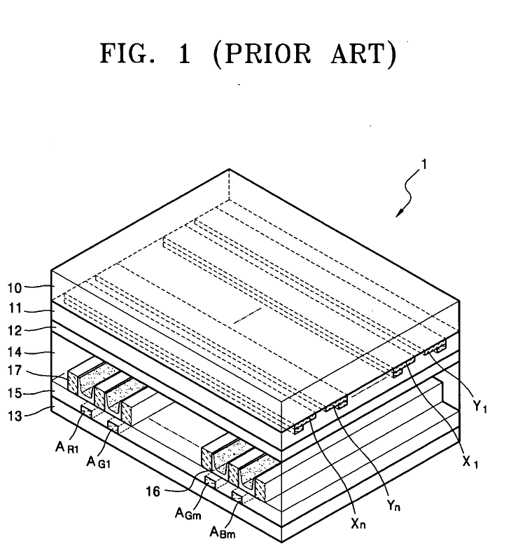

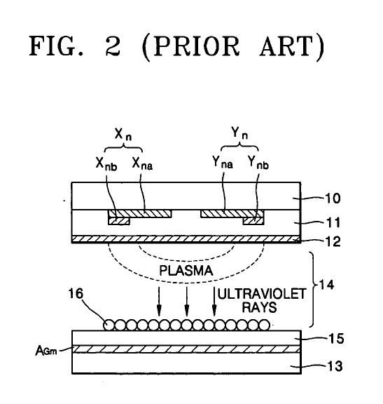

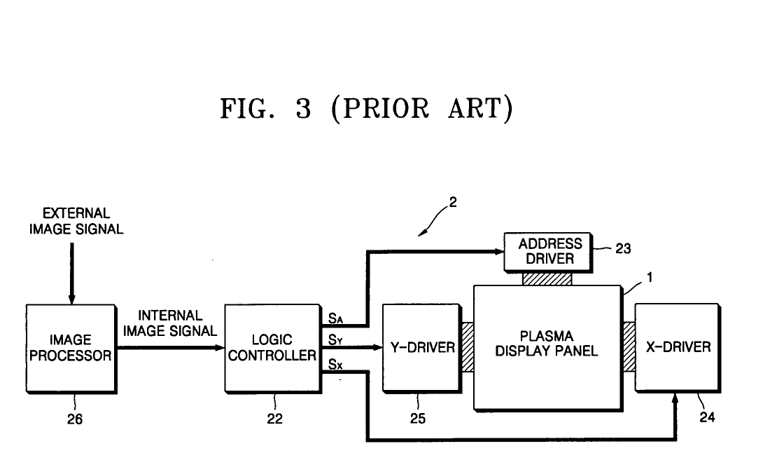

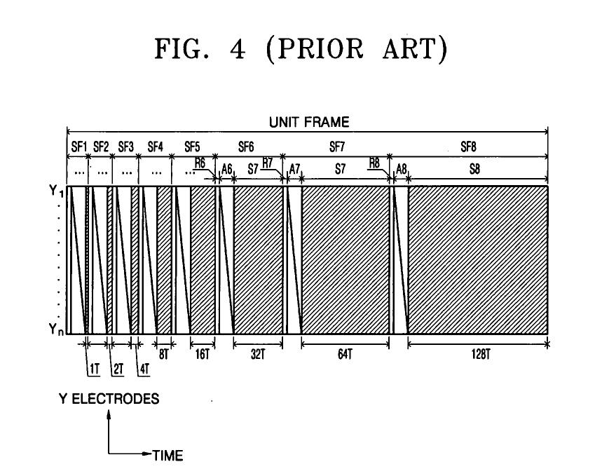

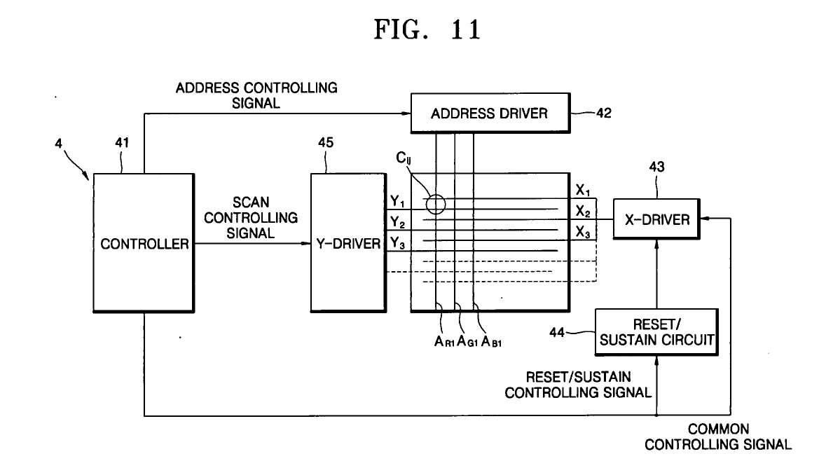

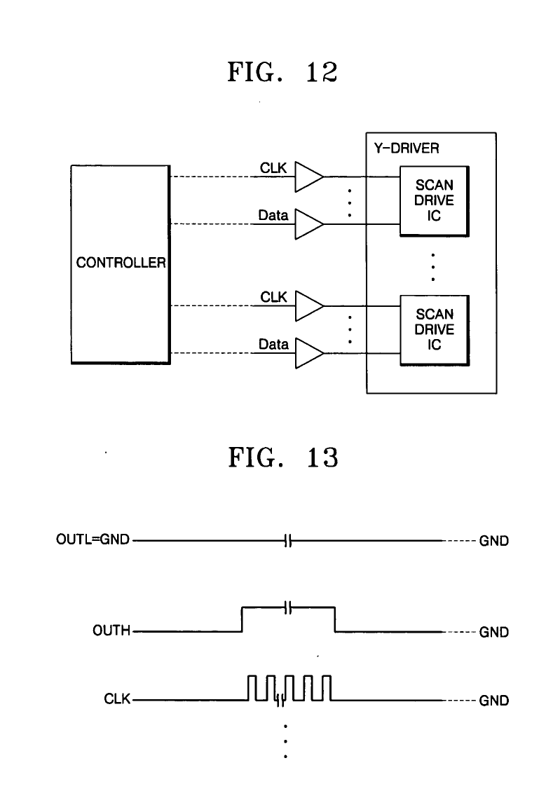

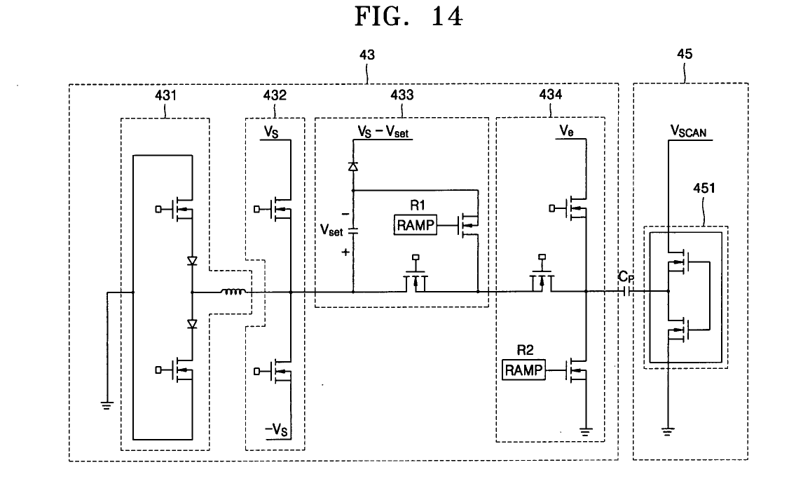

FIG. 11 is a block diagram showing an apparatus for driving a PDP according to an exemplary embodiment of the present invention, FIG. 12 is a block diagram showing a scan driver of the apparatus shown in FIG. 1 1, and FIG. 14 is a circuit diagram showing an X-driver and a Y-driver of the PDP shown in FIG. 11.

Referring to FIG. 11, an apparatus 4 for driving a PDP includes a controller 41, a Y-driver 45, an address driver 42, a reset/sustain circuit 44, and an X-driver 43. Parallel pairs of sustain electrode lines, comprising the X-electrode lines X₁, . . . , Xₙ and Y-electrode lines Y₁, . . . , Yₙ are alternately arranged and are disposed to be orthogonal to address electrode lines A_{R1}, A_{G1}, A_{B1} . . . Intersections between the sustain electrode lines and the address electrode lines define discharge cells Cᵢⱼ.

The controller 41 processes input image data to generate a scan controlling signal, an address controlling signal, a reset/sustain controlling signal, and a common controlling signal. The Y-driver 45 applies a scan drive signal to the Y-electrode lines Y₁, . . . , Yₙ in response to the scan controlling signal. The address driver 42 applies an address drive signal to the address electrode lines A_{R1}, A_{G1}, A_{B1} . . . in response to an address controlling signal. The reset/sustain circuit 44 applies a reset/sustain drive signal to the X-electrode lines X₁, . . . , Xₙ in response to the reset/sustain controlling signal, and the X-driver 43 applies a common drive signal to the X-electrode lines X₁, . . . , Xₙ in response to the common controlling signal.

The Y-driver 45 may include a scan driver that applies a scan pulse to the Y-electrode lines Y₁, . . . , Yₙ in order to address the Y-electrode lines Y₁, . . . , Yₙ during the address period PA.

Here, the scan controlling signal output from the controller 41 is not electrically isolated, and it may be directly input to the scan driver. As shown in FIG. 14, a ground connected to the scan driver 451 may be an absolute ground GND. Also, the scan controlling signal may be maintained at a ground level GND during each the reset period PR and the sustain period PS. [00701 The X-driver 43 may provide a reset pulse and a sustain pulse to the X-electrode lines X₁, . . . , Xₙ during the reset period PR and the sustain period PS, as wells as bias the X-electrode lines X₁, . . . , Xₙ to a fourth level Vₑ on the basis of the reference level GND during the address period PA.

Accordingly, as shown in FIG. 14, an apparatus for driving a PDP may include a panel capacitor C_{P}, which has one terminal connected to an X-driver 43 and the other terminal connected to a Y-driver 45.

The X-driver 43 may include an energy retriever 431, a sustain voltage generator 432, a reset circuit 433, and a bias voltage generator 434. The Y-driver 45 may include a scan driver 451 that applies a scan voltage V_{scan} to Y-electrode lines.

The energy retriever 431 retrieves and charges charge/discharge energy to the panel capacitor C_{P}. The sustain voltage generator 432 applies a positive sustain voltage V_{S} and a negative sustain voltage −V_{S} to X-electrode lines. The reset circuit 433 applies a reset voltage to the X-electrode lines and may include a negative ramp voltage generator R₁. The bias voltage generator 434 applies a bias voltage to the X-electrode lines during the address period and may include a ramp voltage generator R₂ for applying the bias voltage.

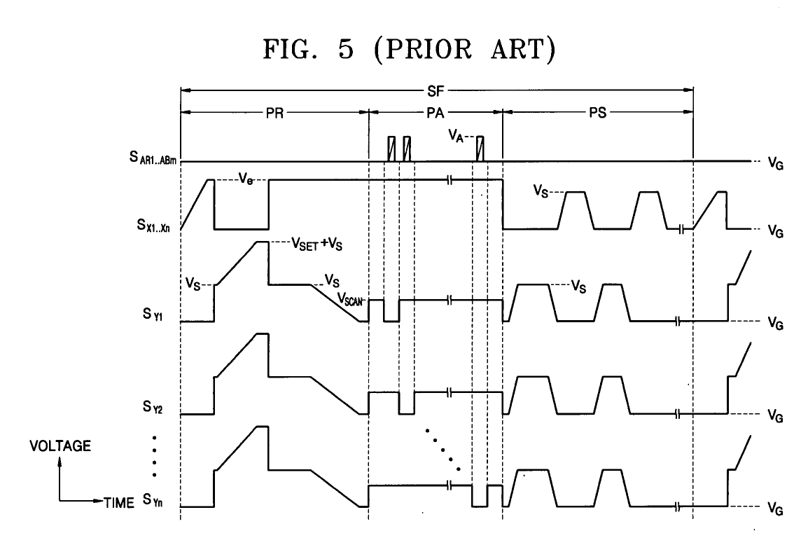

A conventional apparatus for driving a PDP may employ the Y-driver 25 shown in FIG. 6 to apply a voltage having the waveform shown in FIG. 5 to respective electrode lines. The conventional Y-driver 25 may include a sustain voltage generator, a reset circuit including a ramp, and a bias voltage generator. However, as shown in FIG. 14, according to an exemplary embodiment of the present invention, the X-driver 43 includes the energy retriever 431, the sustain voltage generator 432, the reset circuit 433, and the bias voltage generator 434 in order to apply a voltage having the waveform shown in FIG. 9 or 10 to respective electrode lines.

As noted above, the conventional apparatus for driving a PDP may require an optocoupler capable of using a floating ground in order to apply a scan pulse, a sustain voltage, a reset voltage, and a bias voltage to a Y electrode line.

However, in the apparatus according to exemplary embodiments of the present invention, the Y-driver 45 includes the scan driver 451 for applying a scan pulse to the Y-electrodes, while the X-driver 43 includes the energy retriever 431, the sustain voltage generator 432, the reset circuit 433, and the bias voltage generator 434. Thus, an optocoupler is not required.

Since the apparatus of the present invention drives a PDP according to the PDP driving method illustrated in FIG. 9 or FIG. 10, a detailed description of its function and effect is omitted here.

As explained thus far, the present invention does not require an isolating device, such as an optocoupler, which is conventionally used to electrically isolate a scan controlling signal applied to a scan drive IC. Hence, the scan electrode driving circuitry may be simplified.

Also, the present invention solves problems that may be caused by a failure of an isolating device such as an optocoupler, which may often occur when PDPs are conventionally produced in bulk, thus greatly increasing yield.

Further, when only a scan discharge is performed in scan electrodes, and not a reset or sustain discharge, a driver board integrating X-electrodes and Y-electrodes may be easily designed.

Also, because an isolating device, such as an optocoupler, which accounts for a large portion of a PDP's production cost is not needed, the production cost may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for driving a plasma display panel in which X-electrode lines, Y-electrode lines and address electrode lines define discharge cells, and in which a unit frame as a display period is divided into a plurality of subfields to realize time-division grayscale display, the method comprising:
dividing a subfield into a reset period, an address period, and a sustain period;
maintaining the Y-electrode lines at a reference level during the reset period and the sustain period; and
biasing the Y-electrode lines to a first level and simultaneously applying a sequential scan signal of the reference level to the Y-electrode lines during the address period.

2. The method of claim 1, further comprising:
during the reset period,
applying a falling ramp pulse that falls from a second level to a third level and then a rising ramp pulse that rises from the reference level to a fourth level to the X-electrode lines.

3. The method of claim 2, further comprising:
during the address period,
maintaining the X-electrode lines at the fourth level.

4. The method of claim 1, further comprising:
during the sustain period,
alternately applying a positive sustain pulse having a second level and a negative sustain pulse having the second level to the X-electrode lines.

5. The method of claim 1, wherein the reference level is a ground voltage.

6. A method for driving a plasma display panel in which X-electrode lines, Y-electrode lines and address electrode lines define discharge cells, and in which a unit frame as a display period is divided into a plurality of subfields to realize time-division grayscale display, the method comprising:
dividing a subfield into a reset period, an address period, and a sustain period;
biasing the Y-electrode lines to a first level in a first part of the reset period and maintaining the Y-electrode lines at a reference level in a second part of a reset period;
biasing the Y-electrode lines to the first level and simultaneously applying a sequential scan signal of the reference level during the address period; and
applying a Y sustain pulse of the first level to the Y-electrode lines during the sustain period.

7. The method of claim 6, further comprising:
during a reset period,
applying a falling ramp pulse that falls from a fifth level to a sixth level and a rising ramp pulse that rises from the reference level to a fourth level to the X-electrode lines.

8. The method of claim 7, wherein the falling ramp pulse is applied during the first part of the reset period, and the rising ramp pulse is applied during the second part of the reset period.

9. The method of claim 7, further comprising:
maintaining the X-electrode lines at the fourth level during the address period.

10. The method of claim 7, further comprising:
during the sustain period,
alternately applying a positive sustain pulse of a second level and a negative sustain pulse of the fifth level to the X-electrode lines.

11. The method of claim 10, wherein the Y sustain pulse is applied to the Y-electrode lines at the same time that the negative sustain pulse is applied to the X-electrode lines.

12. The method of claim 7, wherein the fifth level corresponds to a difference between the first level applied to the Y-electrode lines and the second level applied to the X-electrode lines.

13. The method of claim 6, wherein the reference level is a ground voltage.

14. An apparatus of driving a plasma display panel in which X-electrode lines, Y-electrode lines and address electrodes define discharge cells, and in which a unit frame as a display period is divided into a plurality of subfields to realize time-division grayscale display, and a subfield includes a reset period, an address period, and a sustain period, the apparatus comprising:
a controller to generate a scan controlling signal, an address controlling signal, a reset/sustain controlling signal, and a common controlling signal;
a Y-driver applying a scan drive signal to the Y-electrode lines in response to the scan controlling signal;
an address driver applying an address drive signal to the address electrode lines in response to the address controlling signal;
a reset/sustain circuit applying a reset/sustain drive signal to the X-electrode lines in response to the reset/sustain controlling signal; and
an X-driver applying a common drive signal to the X-electrode lines in response to the common controlling signal.

15. The apparatus of claim 14, wherein the Y-driver comprises a scan driver applying a scan pulse to the Y-electrode lines to address the Y-electrode lines during the address period.

16. The apparatus of claim 15, wherein the scan controlling signal output from the controller is electrically directly input to the scan driver.

17. The apparatus of claim 15, wherein a ground connected to the scan driver is an absolute ground.

18. The apparatus of claim 14, wherein the X-driver makes a reset pulse and a sustain pulse pass through the X-electrode lines during the reset period and the sustain period and biases the X-electrode lines to a fourth level during the address period.

19. The apparatus of claim 14, wherein the scan controlling signal is maintained at a ground level during the reset period and the sustain period.
